(19) United States
(12) Patent Application Publication
(10) Pub. No.: US 2018/0174030 A1
(43) Pub. Date: Jun. 21, 2018

(54) SELF-LEARNING FOR NEURAL NETWORK ARRAYS

(71) Applicants: Fu-Chang Hsu, San Jose, CA (US); Kevin Hsu, San Jose, CA (US)

(72) Inventors: Fu-Chang Hsu, San Jose, CA (US); Kevin Hsu, San Jose, CA (US)

(21) Appl. No.: 15/844,457

(22) Filed: Dec. 15, 2017

Related U.S. Application Data
(60) Provisional application No. 62/435,067, filed on Dec. 15, 2016.

(51) Int. Cl. G06N 3/063; G06N 3/04

(52) U.S. Cl. CPC G06N 3/063; G06N 3/04

(57) ABSTRACT

Self-learning for neural network arrays. In an exemplary embodiment, a method includes determining input voltages to be applied to one or more input neurons of a neural network, and determining target output voltages to be obtained at one or more output neurons of the neural network in response to the input voltages. The neural network also includes a plurality of hidden neurons and synapses connecting the neurons, and each of a plurality of synapses includes a resistive element. The method also includes applying the input voltages to the input neurons, and applying the target output voltages or complements of the target output voltages to the output neurons to simultaneously program the resistive elements of the plurality of synapses.

### PRIORITY

This application claims the benefit of priority based upon U.S. Provisional Patent Application having Application No. 62/435,067, filed on Dec. 15, 2016, and entitled “2D AND 3D NEURAL NETWORK CHIP WITH FAST SELF-LEARNING CAPABILITY,” all of which are hereby incorporated herein by reference in their entireties.

### FIELD OF THE INVENTION

The exemplary embodiments of the present invention relate generally to the field of semiconductors, and more specifically to the design and operation of semiconductors forming neural network arrays.

### BACKGROUND OF THE INVENTION

A neural network is an artificial intelligence (AI) system that has learning capabilities. AI systems have been used for may applications such as voice recognition, pattern recognition, and hand-writing recognition to name a few.

The typical neural network having neurons connected by synapses may be implemented by using software or hardware. A software implementation of a neutral network relies on a high-performance CPU to execute specific algorithms. For very high density neural networks, the speed of the CPU may become a bottleneck to the performance of real-time tasks. On the other hand, a hardware implementation typically results in circuit sizes that may limit the density or size of the neural network thereby limiting its functionality.

Neural networks are typically trained to produce a desired output in response to a set of inputs. A first step in a typical training process is called forward-propagation, which calculates an output from a given set of inputs and the existing weights of network's synapses. After that, the output is compared to the desired output to obtain an error value. A second step is then performed called back-propagation and is used to adjust the weights of the synapses according to the error value. This forward/back process is repeated multiple times to program the weights until the error value is below a desired threshold. Unfortunately, this process may require additional hardware to program the weights and can be slow and inefficient since it may take many repetitions of the training cycle to achieve the desire level of network performance.

Therefore, it is desirable to have a way to program the synapse weights of neural network arrays in a fast and efficient manner.

### SUMMARY

Self-learning for neutral network arrays is disclosed. In various exemplary embodiments, a self-learning neural network array includes neurons connected by weighted synapses. In an exemplary embodiment, programming the weights of the synapses is accomplished using a novel direct programming process whereby the weights of the synapses are directly programmed from selected input values and output values. This direct process eliminates the need for alternating forward-propagation and back-propagation steps as used with conventional neural networks. Therefore, a self-learning neural network chip can be realized. During the learning process, the weights may be updated quickly and efficiently one or more times until all the weight values are programmed (e.g., learned). Additional training can be used to achieve more accurate learning results.

In an exemplary embodiment, a method is disclosed that comprises determining input voltages to be applied to one or more input neurons of a neural network, and determining target output voltages to be obtained at one or more output neurons of the neural network in response to the input voltages. The neural network also includes a plurality of hidden neurons and synapses connecting the neurons, and each of a plurality of synapses includes a resistive element. The method also includes applying the input voltages to the input neurons, and applying the target output voltages or complements of the target output voltages to the output neurons to simultaneously program the resistive elements of the plurality of synapses.

In an exemplary embodiment, a method is disclosed for programming resistive elements of synapses of a neural network. The method comprises initializing the resistive elements to low resistive states, determining input voltages to be applied to one or more input neurons of the neural network, and determining target output voltages to be obtained at one or more output neurons of the neural network in response to the input voltages. The method also comprises applying the input voltages to the input neurons, and applying the target output voltages to the output neurons to simultaneously reset each of selected resistive elements to respective high resistive states.

In an exemplary embodiment, a method is disclosed for programming resistive elements of synapses of a neural network. The method comprises initializing the resistive elements to high resistive states, determining input voltages to be applied to one or more input neurons of the neural network, and determining target output voltages to be obtained at one or more output neurons of the neural network in response to the input voltages. The method also comprises determining complementary target output voltages from the target output voltages, applying the input voltages to the input neurons, and applying the complementary target output voltages to the output neurons to simultaneously set each of selected resistive elements to respective low resistive states.

Additional features and benefits of the exemplary embodiments of the present invention will become apparent from the detailed description, figures and claims set forth below.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1A shows an exemplary embodiment of a neural network structure;

FIG. 1B shows an exemplary embodiment of a neuron and its associated functions;

FIG. 1C shows an exemplary embodiment of a synapse element and its associated functions;

FIG. 2A shows an exemplary embodiment of a hardware implementation of a neural network;

FIG. 2B shows another exemplary embodiment of hardware implementation of a neural network;

FIG. 3A shows an exemplary embodiment of a circuit implementation of a neural network that is based on the neural network circuit shown in FIG. 2B;

FIG. 3B shows an exemplary embodiment of a 3D array structure that is constructed based on the neural network shown in FIG. 3A;

FIG. 3C shows an exemplary embodiment of a circuit implementation of a neural network that is based on the neural network shown in FIG. 2A;

FIG. 3D shows an exemplary embodiment of a 3D array structure that implements the circuit shown in FIG. 3C;

FIG. 4A shows an exemplary embodiment of a neural network circuit;

FIG. 4B shows another embodiment of a neural network circuit;

FIG. 5A shows an exemplary embodiment of a circuit that illustrates a SET operation to program resistive elements of a neural network;

FIG. 5B shows another exemplary embodiment of a neural network that has threshold devices (D1-D3);

FIG. 5C shows exemplary current-voltage (I-V) curves of SET and RESET operations of a resistive element in a neural network;

FIG. 6A shows an exemplary embodiment of a circuit that illustrates a RESET operation to program resistive elements of a neural network;

FIG. 6B shows another exemplary embodiment of a neural network that includes threshold devices (D1-D3)

FIG. 6C shows exemplary I-V curves of SET and RESET operations of the resistive element;

FIG. 7A shows an exemplary embodiment of a graph that illustrates how voltage levels of a neural network are set so that the synapse weights are updated directly from input and output voltages during learning operations;

FIG. 7B shows an exemplary embodiment of a graph illustrating how voltage thresholds of threshold devices are taken into account when programming resistive elements;

FIGS. 8A-C show an exemplary embodiment of a neural network that illustrates various exemplary programming operations; and

FIG. 9 shows an exemplary embodiment of a method for programming resistive elements of synapses of a neural network.

### DETAILED DESCRIPTION

Those of ordinary skilled in the art will realize that the following detailed description is illustrative only and is not intended to be in any way limiting. Other embodiments of the present invention will readily suggest themselves to skilled persons having the benefit of this disclosure. Reference will now be made in detail to implementations of the exemplary embodiments of the present invention as illustrated in the accompanying drawings. The same reference indicators or numbers will be used throughout the drawings and the following detailed description to refer to the same or like parts.

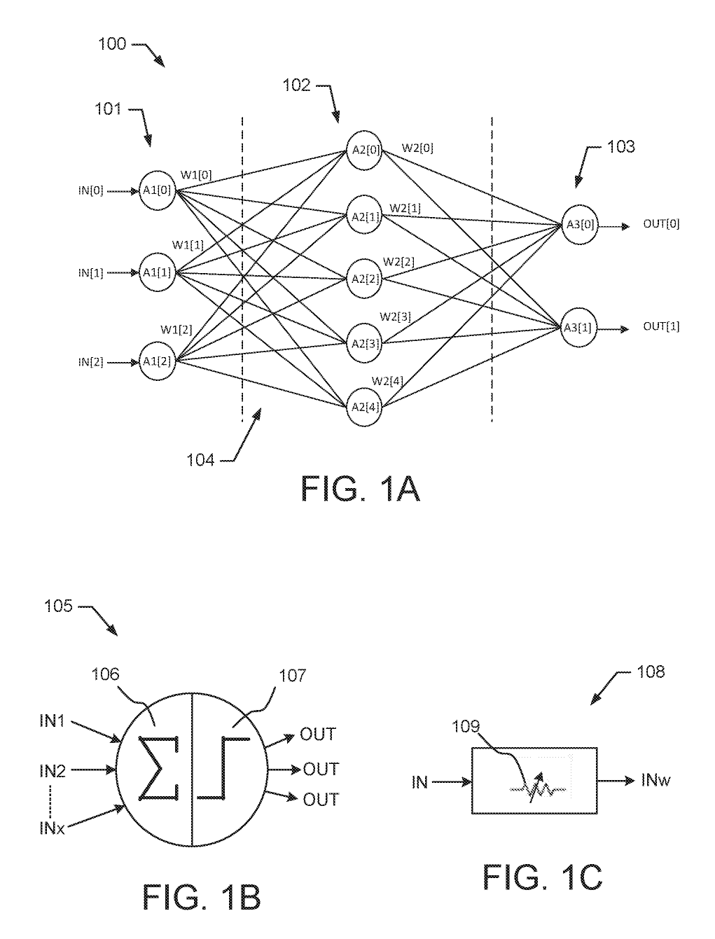

FIG. 1A shows an exemplary embodiment of a neural network structure 100. The neural network structure 100 comprises three layers. The first layer is an input layer 101 that includes three input neurons (A1[0]-A1[2]). A second layer is a hidden layer 102 that includes five neurons (A2[0]-A2[4]). A third layer is an output layer 103 that includes two neurons (A3[0]-A3[1]). In other embodiments, the neural network structure 100 may contain more than one hidden layer, and any number of neurons in each layer. With more layers and more neurons, the neural network structure 100 can learn more complicated tasks.

The neurons of the different layers are connected through synapses 104 that transfer signals between the neurons. Each synapse applies a programmable ‘weight’ to the signal flowing through it. For example, the synapse connecting neurons A1[0] and A2[0] provides weight W1[0] to the signal flowing through it, and the synapse connecting neurons A1[1] and A2[0] provides weight W1[1] to the signal flowing through it, respectively. As illustrated in FIG. 1A, the synapses connecting the input layer 101 neurons to the hidden layer 102 neurons provide programmable weights W1[x], and the synapses connecting the hidden layer 102 neurons to the output layer 103 neurons provide programmable weights W2[x].

During operation, input signals IN(0-2) flow into the input layer 101 neurons and then flow through the synapses to one or more hidden layers of neurons, such as hidden layer 102, and finally flow to the output layer 103 neurons. By adjusting the weights of the synapses it is possible to “train” the neural network 100 to generate a desired set of outputs (OUT(0-1) given a particular set of inputs (IN(0-2)).

FIG. 1B shows an exemplary embodiment of a neuron 105 and its associated functions. For example, the neuron 105 is suitable for use as any of the neurons shown in FIG. 1A. The neuron 105 provides two functions. The first function is a summation function 106, and the second function is a threshold function 107. The summation function 106 determines the sum of input signals (e.g., IN1-INx) that are received by the neuron. The threshold function 107 determines whether the sum exceeds a threshold value. If the sum exceeds the threshold value, the neuron generates one or more output signals (OUT) having a particular output value. For example, for the hidden layer 102 neuron A2[0] shown in FIG. 1A, the sum of its input signals can be determined from the following expression.

A2[0]=(IN[0]×W1[0])+(IN[1]×W1[1])+(IN[2]×W1[2]) (Eq. 1)

Similarly, for the output layer 103 neuron A3[0] shown in FIG. 1A, the sum of its input signals can be determined from the following expression.

A3[0]=(A2[0]×W2[0])+(A2[1]×W2[1])+(A2[2]×W2[2])+(A2[3]×W2[3])+(A2[4]×W2[4]) (Eq. 2)

For each neuron, the sum of its inputs is passed to its threshold function (e.g., 107). When the sum of the inputs is higher than the threshold, the threshold function will generate an output signal to the neuron's output(s). Otherwise, there is no output from the neuron. For example, when the sum of the inputs is higher than the threshold, the neuron may generate a signal of logic 1 to the output. When the sum is lower than the threshold, the neuron may generate a signal of logic 0 to the output. In a hardware implementation, logic 1 may be VDD and logic 0 may be 0V. This mechanism is also known as ‘winner takes all’.

FIG. 1C shows an exemplary embodiment of a synapse element 108 and its associated functions. For example, the synapse element 108 is suitable for use as any of the synapses 104 shown in FIG. 1A. The synapse element 108 comprises a variable weighting function 109 that applies a variable weight to a signal received at the synapse input to generate a weighted signal (INw) at the output of the synapse element. In an exemplary embodiment, the variable weighting function 109 provides either a continuous weighting function or variable weighting in discrete steps. For example, in an exemplary embodiment, the variable weighting function provides variable weighting in 8 steps. For example, in an exemplary embodiment, the variable weighting function provides variable weighting in 8 steps, such as 1K ohm, 5K ohm, 10K ohm, 50K ohm, 100K ohm, 500K ohm, 1M ohm, 5M ohm. In other exemplary embodiments, the synapse element includes a threshold function in addition to the weighting function. A more detailed description of the how the synapse operates to provide the variable weighting function is provided below.

In various exemplary embodiments, novel three-dimensional (3D) neural network arrays are disclosed that utilize resistive elements to implement programmable synapse weights. For example, in various exemplary embodiments, the resistive elements comprises resistive material such as that used in resistive random-access memory (RRAM) or phase-change memory (PCM). In exemplary embodiments, three types of 3D neural network arrays can be implemented and are referred to as a cross-point array, a vertical array, and a horizontal array.

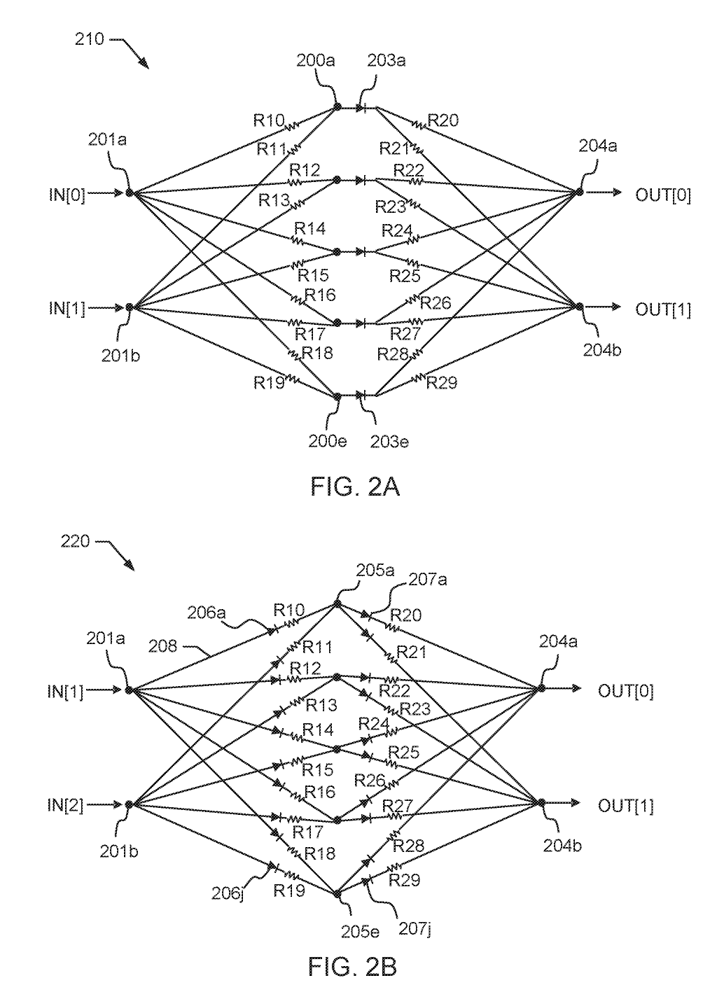

FIG. 2A shows an exemplary embodiment of a hardware implementation of a neural network 210. The neural network 210 includes input neurons 201a-b that receive input signals IN[0-1], hidden neurons 200a-e, and output neurons 204a-b that output the output signals OUT[0-1]. The weights of synapses are implemented by resistive elements, such as resistors R10-R19 in a first layer and resistors R20-R29 in a second layer. The nodes 200a-e are the neurons of the hidden layer. A threshold function is implemented by using suitable threshold devices 203a-e, such as diodes, Schottky diodes, or another type of threshold device, which form part of the hidden neurons 200a-e.

In an exemplary embodiment, the resistive elements of the synapses are implemented by using resistive materials, such as HfO/HfOx for example. In another embodiment, the resistive elements are implemented by using phase change materials, such as chalcogenide for example. In another embodiment, the resistive elements are implemented by using ferroelectric materials, such as Ziconate Titanate for example. In another embodiment, the resistive elements are implemented by using magnetic materials, such as iron, nickel, or cobalt for example.

FIG. 2B shows another exemplary embodiment of a hardware implementation of a neural network 220. For example, the network 220 is a variation of the network 210. The network 220 includes threshold devices in each synapse, such as threshold devices 206a-j and 207a-j. Thus, each synapse includes two devices, such as the synapse 208 that includes a resistive element R10 and a threshold device 206a. The nodes 205a-e are the neurons of the hidden layer. In various exemplary embodiments, the neural networks shown in FIGS. 2A-B may be implemented as two-dimensional (2D) or three-dimensional (3D) arrays using resistive material such as phase-change material for each resistive element.

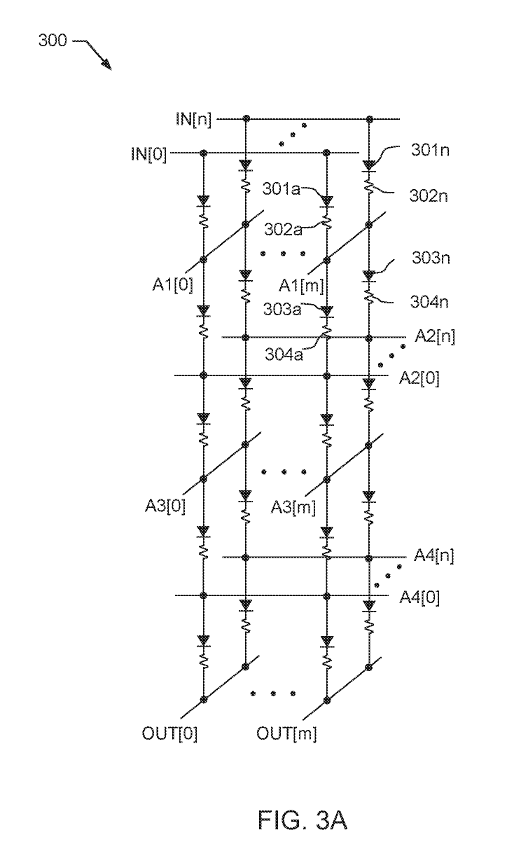

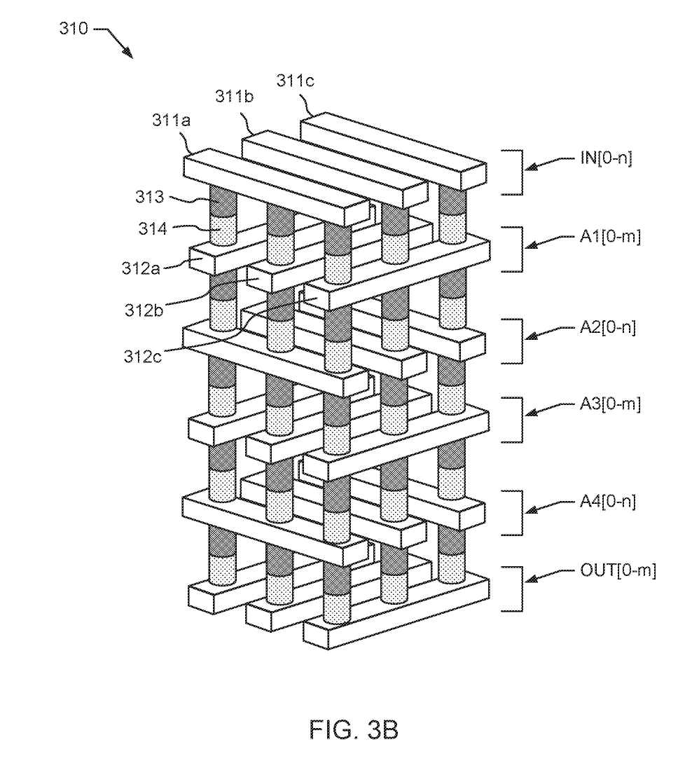

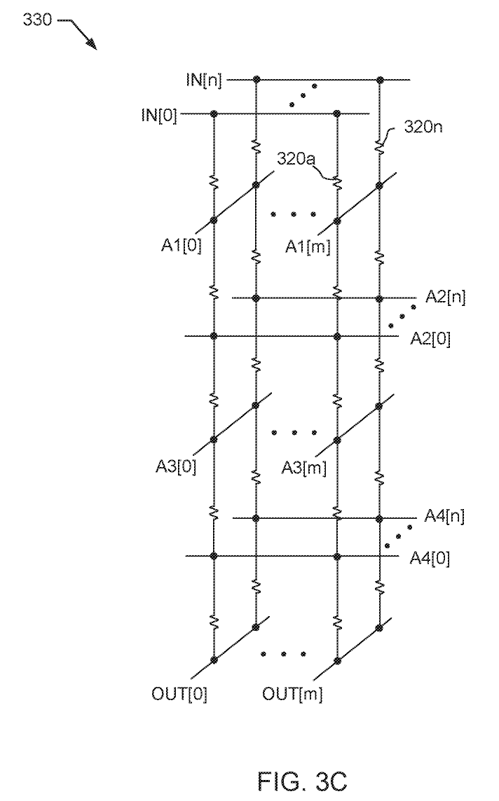

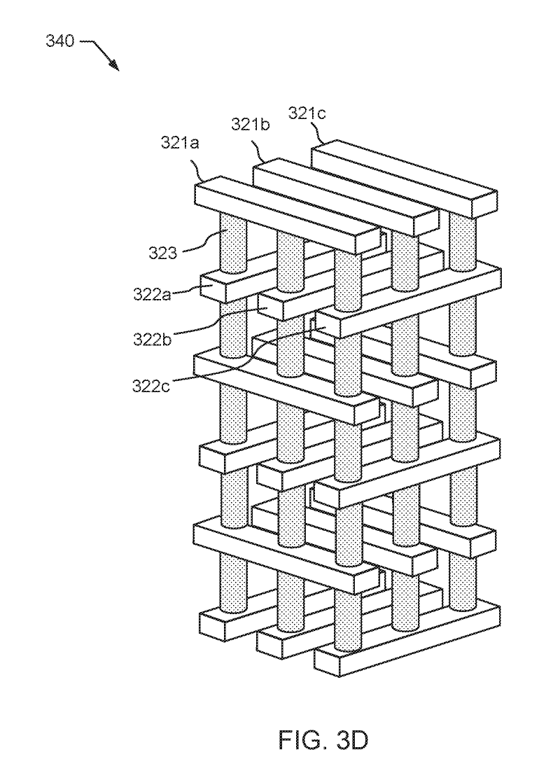

FIG. 3A shows an exemplary embodiment of a circuit implementation of a neural network 300 that is based on the neural network circuit shown in FIG. 2B. For example, a first layer includes synapses having threshold devices 301a to 301n and resistive elements 302a to 302n. A second layer includes synapses having threshold devices 303a to 303n and resistive elements 304a to 304n. This circuit structure is repeated for multiple hidden layers until the output neurons OUT[0-m] are reached.

FIG. 3B shows an exemplary embodiment of a 3D array structure 310 that is constructed based on the neural network 300 shown in FIG. 3A. For example, the array structure 310 shows the input layer, four hidden layers, and the output layer as illustrated in FIG. 3A. The input layer IN[0-n] comprises conductors 311a-c and the first hidden layer A1[0-m] comprises conductors 312a-c. The conductors comprise any suitable metal, such as tantalum (Ta), platinum (Pt), titanium (Ti). Connecting the input layer neurons IN[0-n] with the first hidden layer neurons A1[0-m] are synapses that comprise selectors (e.g., selector 313) that comprise a diode, Schottky diode, or other material having threshold behavior such as NbOx, TaOx, and VCrOx. The synapses also comprise resistive elements (e.g., resistive element 314) that comprises a resistive material such as HfOx or TaOx. In an exemplary embodiment, the resistance value of the resistive elements of the synapses may be changed by applying proper bias conditions to the conductors. For example, the resistance value of the resistive element 314 can be set or changed by applying the proper bias conditions to the conductors 311a and 312a.

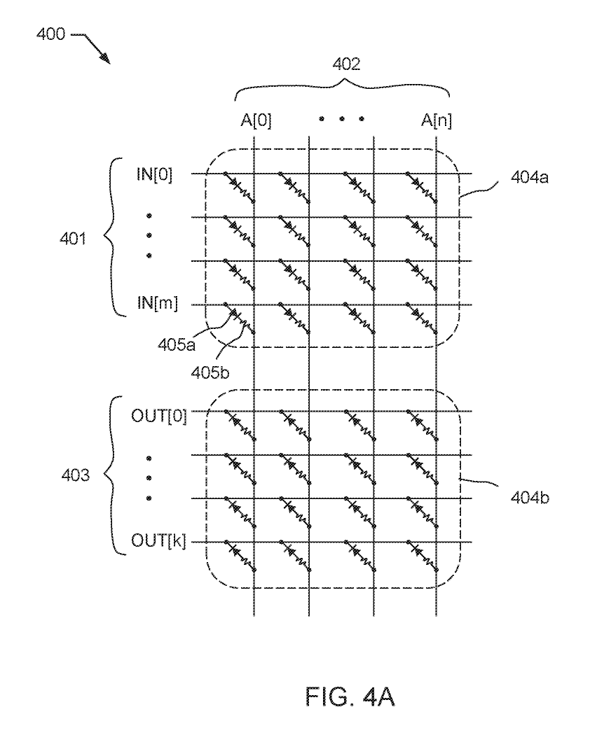

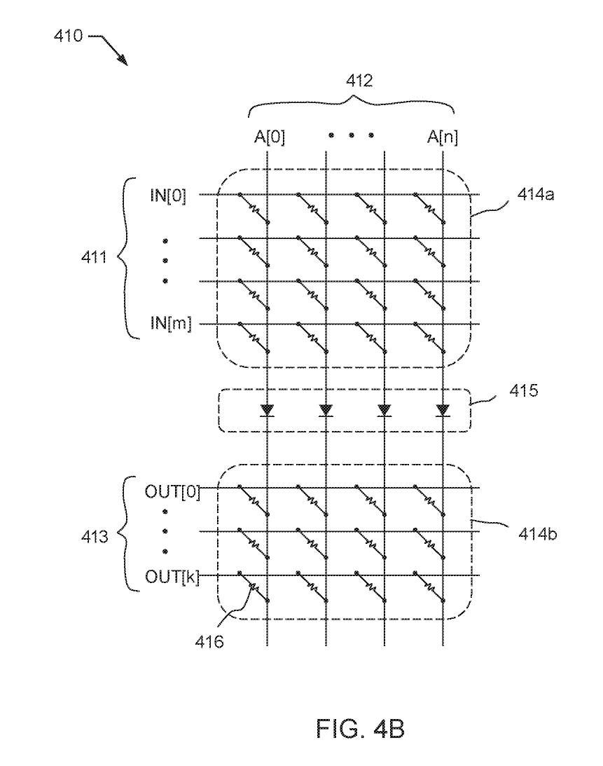

FIG. 3C shows an exemplary embodiment of a circuit implementation of a neural network 330 that is based on the neural network 210 shown in FIG. 2A. For example, the resistive elements 320a-n are representative of the resistive elements R10-R19 as shown in FIG. 2A. In this embodiment, the threshold devices 203 (not shown) can be connected to the neurons outside of the array 330, for example, an array with external diodes is shown in FIG. 4B.

FIG. 3D shows an exemplary embodiment of a 3D array structure 340 that implements the circuit shown in FIG. 3C. For example, the array structure 340 shows the input layer, four hidden layers, and the output layer as illustrated in FIG. 3C. The input layer IN[0-n] comprises conductors 321a-c and the first hidden layer A1[0-m] comprises conductors 322a-c. The conductors comprise suitable metals for such as Ta, Pt, Ti, or other suitable metal. Also shown are resistive elements connected between the conductors, such as resistive element 323 that comprises HfOx, TaOx, or other resistive material. The resistance of the resistive elements (e.g., resistive element 323) can be programmed or changed by applying proper bias conditions. For example, the resistive element 323 can be programmed by applying the appropriate bias conditions to the conductors 321a and 322a.

FIG. 4A shows an exemplary embodiment of a neural network circuit 400 that comprises input layer neurons (or signal lines) 401, hidden layer neurons (or signal lines) 402, and output layer neurons (or signal lines) 403. The input layer neurons 401 are connected to the hidden layer neurons 402 by synapses 404a, and the hidden layer neurons 402 are connected to the output layer neurons 403 by synapses 404b. The synapses 404a and 404b includes selectors, such as selector 405a which may be a diode or other threshold device, and resistive elements, such as resistor 405b.

FIG. 4B shows another exemplary embodiment of a neural network circuit 410 that comprises input layer neurons (or signal lines) 411, hidden layer neurons (or signal lines) 412, and output layer neurons (or signal lines) 413. The input layer neurons 411 are connected to the hidden layer neurons 412 by synapses 414a, and the hidden layer neurons 412 are connected to the output layer neurons 413 by synapses 414b. The synapses 414a and 414b includes resistive elements, such as resistor 416. The hidden layer neurons 412 include threshold devices between the connections to the synapses 414a and 414b. For example, the threshold devices 415 have inputs connected to the resistive elements of the synapses 414a and outputs connected to the resistive elements of the synapses 414b. The selector 415 includes threshold devices such as diodes.

In an exemplary embodiment, the neural network's weights (which are provided by the resistive elements) are updated by novel methods that apply selected input signals to the inputs and target signals to the outputs of the neural network. In doing so, the resistances of the resistive elements are directly changed, for example, by using SET and/or RESET operations. The SET operation sets a resistive element to a particular low-resistance state and the RESET operation resets a resistive elements to a particular high-resistance state. The SET and RESET operations control the voltages across the resistive elements and the directions of those voltages. In various exemplary embodiments, novel methods are used to SET or RESET the resistive elements to desired resistance values automatically by applying the proper bias conditions according to the target outputs. These novel methods eliminate the use of conventional forward-propagation and back-propagation iterations and thus greatly reduces the learning time of the neural network and enhances the performance.

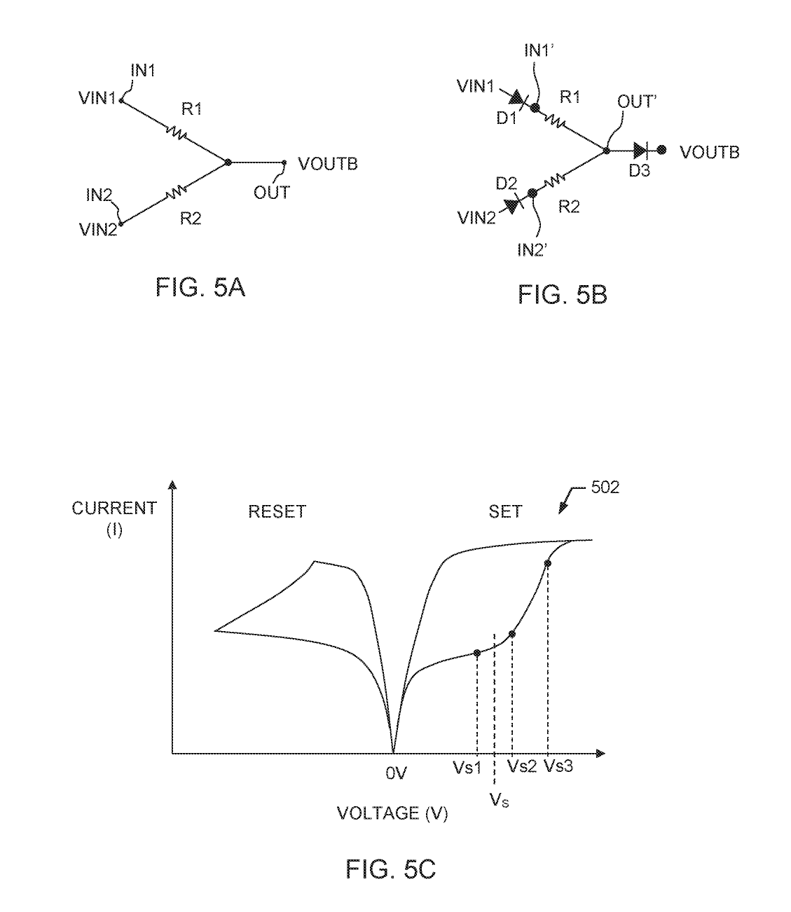

FIG. 5A shows an exemplary embodiment of a circuit that illustrates a SET operation to program resistive elements of a neural network. For example, in one embodiment, the resistive elements comprise resistive material formed from GeOx/TiO2/TaON. Several examples of suitable resistive materials for use as resistive elements are described in U.S. Patent Office Pre-Grant Publication U.S. Pat. No. 8,791,444B2 entitled “Resistive Random Access Memory (RRAM) Using Stacked Dielectrics and Methods for Manufacturing the Same.” The resistive material can be SET to a particular low resistive state by applying a bias voltage that exceeds a selected threshold value across the material in a first direction. For example, the resistive element R1 may be SET to a low resistive state by applying a high voltage between the IN1 and OUT terminals, with IN1>OUT and (IN1-OUT) exceeding a selected SET programming threshold voltage of the resistive material. The resistive material can be RESET to a particular high resistive state by applying a bias voltage that exceeds a selected threshold value across the material in a second direction. For example, the resistive element R1 may be RESET to a high resistive state by applying a reverse high voltage between the IN1 and OUT terminals, with IN1<OUT and (OUT-IN1) exceeding a selected RESET programming threshold voltage of the resistive material.

For example, assuming that the programmable resistive elements R1 and R2 are initially reset to a high resistance state and it is desired to SET the resistive elements to a lower resistive state if necessary based on the applied voltages. The input voltages VIN1 and VIN2 are applied to the inputs (IN1 and IN2). A complementary voltage of VOUTB is applied to the output terminal (OUT). The complementary voltage VOUTB is determined from a target VOUT voltage. For example, a higher target VOUT voltage translates to a lower VOUTB voltage. Exemplary complementary voltages for given target voltages are shown in Table 1 below.

TABLE 1

| Target VOUT voltage | Complementary VOUTB voltage |
|---|---|
| 0 volts | 5 volts |
| 1 volt | 4 volts |
| 2 volts | 3 volts |
| 3 volts | 2 volts |
| 4 volts | 1 volt |
| 5 volts | 0 volts |

It should be noted that the above values are exemplary and that there are many ways to set the complementary voltages within the scope of the embodiments. Using the above values, it will be assumed that VIN1 is 5V, VIN2 is 0V, and the target VOUT is 4V. Thus, from Table 1 the value of VOUTB is 1V. When the voltages for VIN1, VIN2, and VOUTB are applied to the circuit shown in FIG. 5A, the high voltage difference between VIN1 and VOUTB will exceed the SET programming threshold and cause the resistive element R1 to be set to a particular lower resistance level. Therefore, during forward propagation, when VIN1 is supplied with 5V, the output will become higher and closer to 4V due to the lower resistance provided by R1. On the other hand, the resistive element R2 will remain at the high resistance level due to the small voltage difference between VIN2 (0V) and VOUTB (1V), which does not exceed the programming threshold. Thus, during forward propagation, when VIN2 is supplied with 0V, this voltage will not pull the output low very much due to the high resistance of R2. Therefore, after R1 is set (and R2 remains unchanged), when 5V and 0V are applied as VIN1 and VIN2, respectively, the target voltage 4V is produced at the output (OUT). It should also be noted that in some application, VIN and VOUT may only contain digital voltage levels, such as 0V and 5V to represent data 0 and 1. In this case, the VOUTB for 0V and 5V may be 5V and 0V, respectively.

FIG. 5B shows another exemplary embodiment of a neural network that has threshold devices (D1-D3). In this embodiment, the inputs and output include a threshold voltage (Vt) drop from the threshold devices. In various exemplary embodiment, these threshold voltage drops are accounted for when programming the resistive elements R1 and R2. For example, programming can be performed as described above in FIG. 5A with respect to the terminals IN1′, IN2′ and OUT′.

FIG. 5C shows exemplary current-voltage (I-V) curves of SET and RESET operations of a resistive element in a neural network. To illustrate the SET operation described with reference to FIG. 5A, the SET curves 502 will be referenced. As described above, when a lower resistance is desired, a high voltage difference between the input and output will result in the resistive element being set to a lower resistance. Therefore, after the resistive element is SET, the lower resistance will result in a smaller voltage difference between the input and output when using the neural network in forward operation.

To illustrate an example, it will be assumed that in FIG. 5C, the set voltages Vs1, Vs2, and Vs3 are 2V, 3V, and 4V, respectively. Vs1, Vs2, and Vs3 represent target output voltages. Referring now to FIG. 5A, it will be further assumed that 5V and 0V are applied to VIN1 and VIN2, respectively, and the target voltage for VOUT is 4V (Vs3). The complementary voltage 1V is applied to VOUTB to set the resistive element R1 as described above. This generates a 4V SET voltage, as shown by Vs3. FIG. 5C shows a set voltage threshold (V_{S}) above which the resistive element becomes programmable. As a result of Vs3 being greater than Vs, the resistive element R1 will be set to a low resistance value (determined from the level of Vs3) that passes a corresponding amount of current, as shown in FIG. 5C. Therefore, during forward-propagation, when applying 5V and 0V to VIN1 and VIN2, respectively, the VOUT may be pull to the target value of 4V by R1.

Furthermore, in another case, assume a lower target output 2V is desired. In this case, the complementary voltage 3V (from Table 1) will be supplied as VOUTB. This creates a lower SET voltage 2V for R1, as shown in Vs1. This voltage will not set the resistive element to the low resistance state. As a result, during forward-propagation, when 5V and 0V are applied to VIN1 and VIN2, respectively, VOUT may be only pulled up to 2V. Therefore, by applying the inputs and the complementary voltage of the outputs, the resistive elements may be directly set to the target value without using the conventional back-propagation approach.

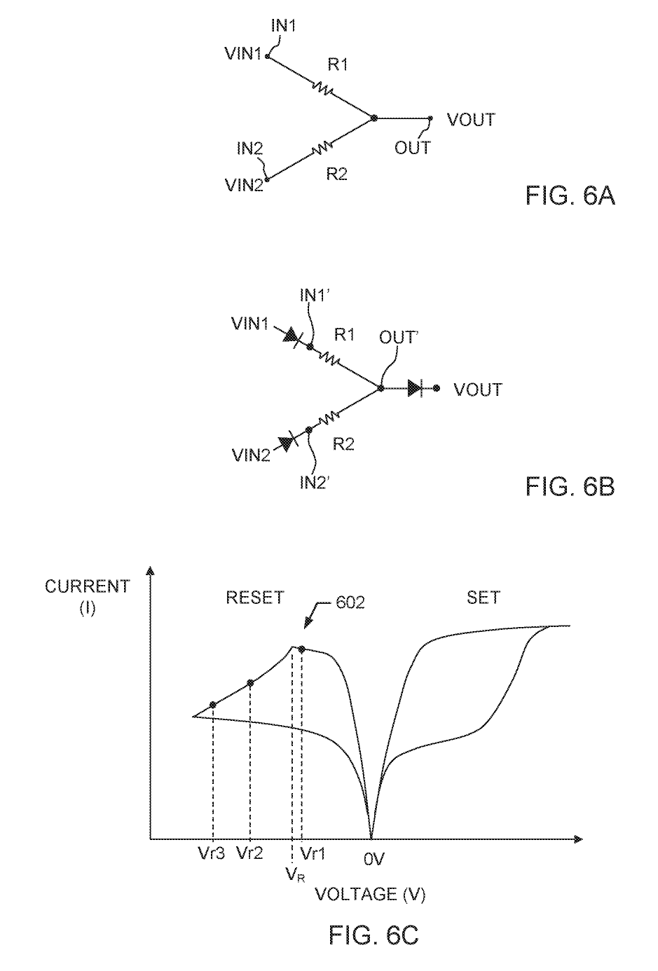

FIG. 6A shows an exemplary embodiment of a circuit that illustrates a RESET operation to program resistive elements of a neural network. For example, the resistive elements R1 and R2 may be RESET to a high resistive state by applying a high voltage between the IN1 and OUT terminals, with IN1<OUT. The RESET operation will increase the resistance of the resistive element. Therefore, unlike the SET operation that uses VOUTB to decrease the resistive element's resistance, for the RESET operation, the target VOUT will be directly used to increase the resistive element's resistance. For example, it will be assumed that the resistive elements R1 and R2 are initially set to low resistance. To RESET the resistive elements to a high resistance state, the input voltages VIN1 and VIN2 and the target output voltage of VOUT are applied. For example, it will be assumed that VIN1 is 5V, VIN2 is 0V, and the target VOUT is 4V. Thus, the high voltage difference between VIN2 and VOUT exceeds the RESET programming threshold and will cause the resistive element R2 to be reset to a higher resistance. On the other hand, the resistive element R1 will remain at low resistance due to the insufficient (smaller) voltage difference between VIN1 and VOUT. Therefore, after R2 is RESET to high resistance, when 5V and 0V are applied to VIN1 and VIN2, respectively, the target voltage 4V at VOUT is produced.

FIG. 6B shows another exemplary embodiment of a neural network that includes threshold devices (D1-D3). In this embodiment, the inputs and output may have a threshold voltage (Vt) drop from the threshold devices. In various exemplary embodiment, these threshold voltage drops are accounted for when programming the resistive elements R1 and R2. For example, programming can be performed as described above with respect to the terminals IN1′, IN2′ and OUT′. It should be noted that although the diodes are unidirectional, because the typical SET and RESET voltages to program the resistive element are higher than the breakdown voltage of the diodes, the resistive elements can be correctly SET or RESET without any problem.

FIG. 6C shows exemplary I-V curves of SET and RESET operations of the resistive element. To illustrate the RESET operation described with reference to FIG. 6A, the RESET curves 602 will be referenced. As described above, when a high resistance is desired, a high voltage difference between the output and the input (e.g., the difference exceeds programming voltage in correct direction) will result in the resistive element being RESET to a higher resistance. Therefore, after the resistive element is RESET, the higher resistance will result in a higher voltage difference between the input and output when using the neural network in forward propagation.

To illustrate an example, it will be assumed that in FIG. 6C, the reset voltages Vr1, Vr2, and Vr3 are −2V, −3V, and −4V, respectively. Referring now to FIG. 6A, it will be assumed that 5V and 0V are applied as VIN1 and VIN2, respectively, and the target voltage for VOUT is 4V. The target voltage 4V is directly applied to VOUT to reset the resistive element R2. This generates a −4V RESET voltage, as shown Vr3. FIG. 6C shows a reset voltage threshold (V_{R}) above which the resistive element becomes programmable. As a result of Vr3 having a larger negative value than V_{R}, the resistive element R2 will be reset to a high resistance value (determined from the level of Vr3) that passes a corresponding amount of current, as shown in FIG. 6C. The voltage difference across R1 (5V-4V) is too small to enable resetting of that device. Therefore, during forward-propagation, when applying 5V and 0V to VIN1 and VIN2, respectively, the VOUT will not be pulled low by VIN2, but will be pulled high by R1 toward the target 4V.

In another case, assume a lower target output 2V is desired. As before, the target voltage 2V will be applied to the VOUT. This creates a lower RESET voltage −2V for R2, as shown in Vr1. This voltage is not large enough to reset this resistive element to the high resistance state. As a result, during forward-propagation, when 5V and 0V are applied to VIN1 and VIN2, respectively, the VOUT may be pulled low to 2V. Therefore, by applying the input voltage to the inputs and the target voltage to the outputs, the resistive elements may be directly set to the target value without using the conventional back-propagation approach.

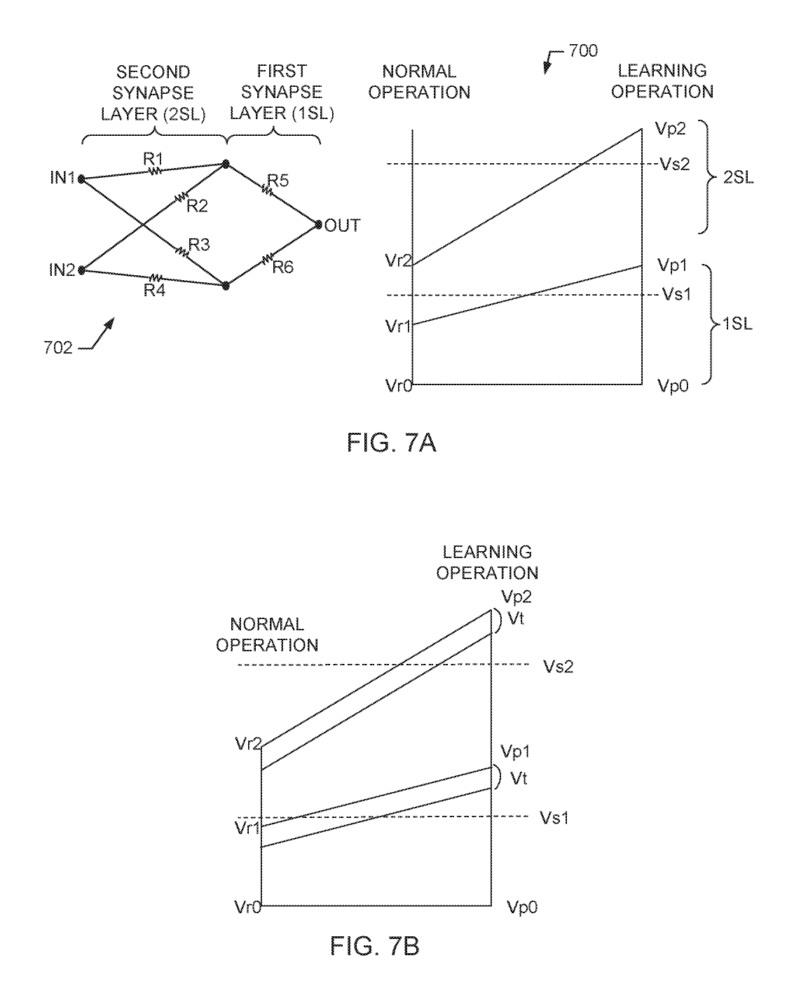

FIG. 7A shows an exemplary embodiment of a graph 700 that illustrates how voltage levels of a neural network 702 are set so that the synapse weights are updated directly from input and output voltages during learning operations. The synapse weights stay unchanged during normal operation (forward propagation). For example, during normal operation, when the neural network 702 produces an output from the inputs, the voltage level for the first synapse layer (SL1) is Vr0-Vr1, and the voltage level for the second synapse layer (SL2) is Vr1-Vr2. The levels of Vr1 and Vr2 must be lower than Vs1 and Vs2, respectively, to prevent SET or RESET operation. For example, the voltages Vs1 and Vs2 cause the resistive elements to be SET or RESET. Therefore, if Vr1 and Vr2 are lower than Vs1 and Vs2, respectively, the resistance of the resistive elements will not be changed. For example, it will be assumed that the resistive elements will be SET or RESET at 3V. The limit voltage levels for the first layer and second layer, Vs1 and Vs2, will be 3V and 6V, respectively. Therefore, during normal operation, the voltage level of the SL1 (Vr1) must be lower than 3V, and the voltage level of the SL2 (Vr2) must be lower than 6V as illustrated in the graph 700. This will prevent the resistive elements from being accidentally set or reset during normal operation.

During learning operation, the input and output levels may be enlarged to Vp0 to Vp1 for the first layer and Vp1 to Vp2 for the second layer. The level of Vp1 and Vp2 are higher than Vs1 and Vs2, respectively. For example, Vs1 and Vs2 may be 3V and 6V, respectively. This will cause the resistive elements to be set and reset by the voltage difference between the input and output voltages. Thus, during the learning operation, the input and output voltages can be scaled to exceed programming voltage thresholds to enable SET or RESET of the resistive elements. Then during normal operation, the input voltages are returned to their original level to obtain the desired output voltages based on the programmed resistive elements.

FIG. 7B shows an exemplary embodiment illustrating how voltage thresholds of threshold devices are taken into account when programming resistive elements. For example, if threshold devices are associated with the resistive element, for example, as shown in FIG. 5B and FIG. 6B, the threshold voltage (Vt) drop of the input and output levels must be taken into account to determine the voltage levels, as shown in FIG. 7B.

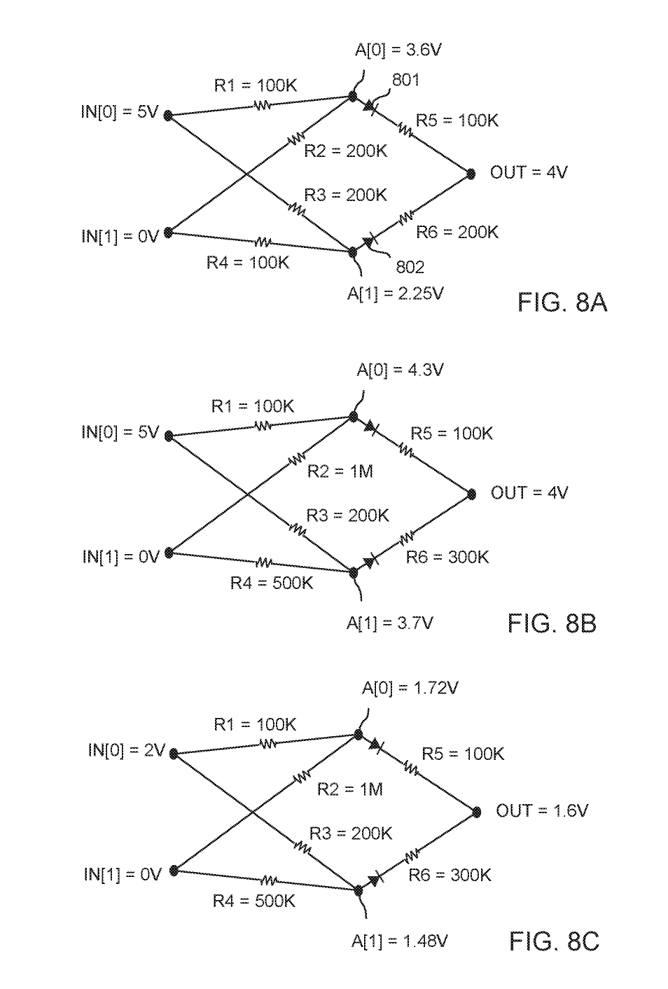

FIGS. 8A-C show exemplary embodiments of a neural network that illustrate various exemplary programming operations. Each network shown in FIGS. 8A-C comprises three layers that include an input layer having inputs IN[0] and IN[1] neurons, a hidden layer having neurons A[0] and A[1], and an output layer having an output neuron OUT.

FIG. 8A shows an exemplary embodiment of a neural network that illustrates a learning process. It will be assumed that a RESET operation is performed as shown in FIGS. 6A-C to update the weights. For example, the resistive elements R1-R6 are initially set to a low resistance state, such as 100K ohm-200K ohm. In an exemplary embodiment, resistance values are random instead of uniform which may provide for a better learning result.

As an example, it will be assumed that the desired target values are IN[0]=2V, IN[1]=0V, and OUT=1.6V. In order to set and reset the resistive elements, the input and output levels for this example is scaled up 2.5 times. Therefore, for this example the levels become IN[0]=5V, IN[1]=0V, and OUT=4V as illustrated in FIG. 8A. This makes the voltage levels high enough to set and reset the resistive elements. For simplicity, it will be assumed that the threshold voltage drops of the threshold devices 801 and 802 are negligible such that Vt for these devices equals to 0V. Therefore, when applying the inputs and output to the neural network, the neurons A[0] and A[1] will become 3.6V and 2.25V, respectively. This will cause the resistive elements to be simultaneously reset, depending on the voltage difference between the hidden neurons (A[n]) and the inputs or output.

FIG. 8B shows an exemplary embodiment of the resistive elements of the network shown in FIG. 8A after the reset operation is complete. As illustrated, the resistive element R2 is reset from 200K ohm to 1M ohm because the voltage difference between A[0] to IN[1] is 3.6V. The resistive element R4 is reset from 100K ohm to 500K ohm because the voltage difference between A[1] to IN[1] is 2.25V. The resistive element R6 is reset from 200K to 300K because the voltage difference between OUT and A[1] is 1.75V. All the other resistive elements are not reset because their voltage difference is either too small or the direction is reversed. Please notice, after the reset operation, the voltages of the neurons A[0] and A[1] are changed to 4.3V and 3.7V, respectively.

FIG. 8C shows an exemplary embodiment of the network shown in FIG. 8A that illustrates normal operation of the neural network after the learning process is complete. When the normal levels for the inputs, IN[0]=2V and IN[1]=0V, are applied to the inputs, the neural network will generate the desired (target) output OUT=1.6V. Also, the neurons A[0] and A[1] will be 1.72V and 1.48V, respectively.

During the learning process, the weights may be updated by multiple programming operations of the learning process. The multiple programming operations are applied to the neural network to update the weights until all the weight are ‘learned’. The more programming operations that are used to update the weights, the more accurate the learning results that may be obtained.

Thus, in various exemplary embodiments, a neural network chip may directly update the weights from the inputs and target outputs. Thus, the conventional forward-propagation and back-propagation steps are not needed. Therefore, a fast self-learning neural network chip is realized.

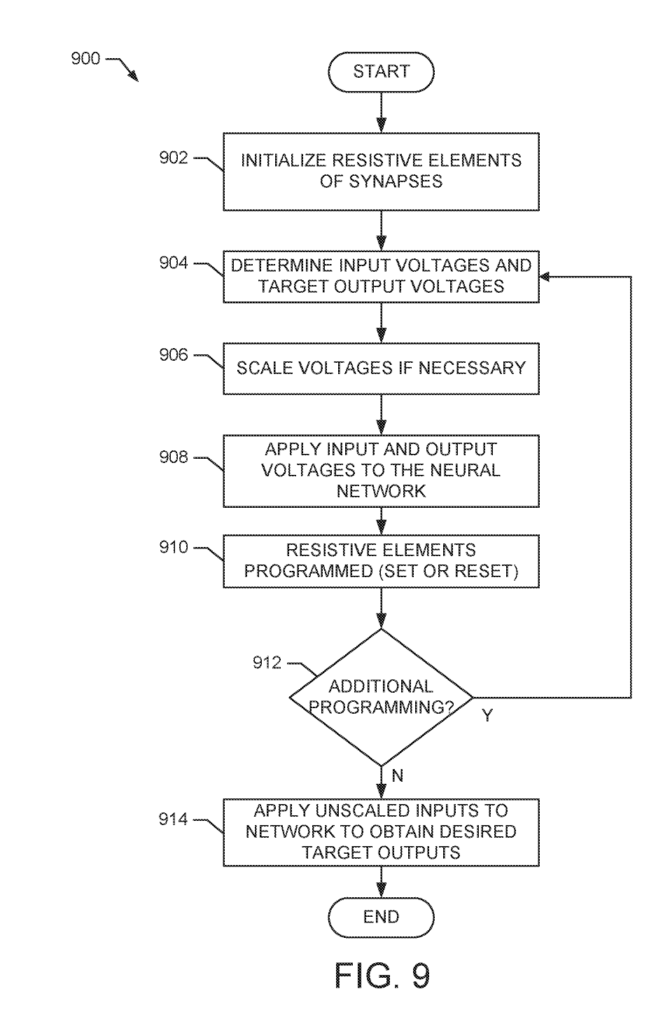

FIG. 9 shows an exemplary embodiment of a method 900 for programming weights of synapse elements of a neural network. For example, the method is suitable for use with the various neural networks shown in FIGS. 2-8. For example, the neural network includes input neurons, hidden neurons, and output neurons that are connected by synapses. Some or all of the synapses include resistive elements as described above. In various exemplary embodiments, the method 900 performs SET, RESET, or both SET and RESET operations to program the resistive elements of a neural network.

At block 902, resistive elements of synapses are initialized. For example, the resistive elements may be initialized to a high resistive state or low resistive state. In another embodiment, the resistive elements are in mixed or random resistive states.

At block 904, input voltages and target output voltages are determined. For example, the input voltages to be applied to one or more input neurons of the neural network are determined. In addition, target output voltages to be obtained at one or more output neurons of the neural network in response to the input voltages are determined. For example, based on whether a SET or RESET operation is to be performed, input voltages and target output voltages are determined. For example, if a SET operation is to be performed, complementary target output voltages are also determined, as illustrated in Table 1. If a RESET operation is to be performed, the target output voltages are used directly.

At block 906, the input, target output, and complementary target output voltages are scaled if necessary to facilitate programming. For example, during normal operation, the voltage levels may be between 0V to 1V. For SET and RESET operation, the voltage levels may be scale up to 0V to 3V, or 0V to 5V, for example, to facilitate programming.

At block 908, the input and target output voltages are applied to the neural network. For example, the input voltages are applied to input neurons of the neural network. The target output voltages are applied to output neurons of the neural network for a reset operation. If a set operation is to be performed, the complementary target outputs are applied to the output neurons.

At block 910, the resistive elements of the neural network are simultaneously programmed in response to the applied input voltages and target (or complementary target) output voltages. For example, the resistive elements are SET and/or RESET based on the applied voltages. For example, FIGS. 5A-C illustrate how the resistive elements are SET, and FIGS. 6A-C illustrate how the resistive elements are RESET.

At block 912, a determination is made as to whether additional programming operations are needed. For example, an additional SET and/or RESET operation can be performed to improve the programming of the resistive elements of the neural network. If additional operation are needed or desired, the method proceeds to block 904. If no additional operations are needed or desired, the method proceeds to block 914.

At block 914, the resistive elements of a neural network have now been simultaneously programmed or trained for normal or forward propagation operation. For example, the unscaled inputs can be applied to the input neurons of the neural network to obtain the target outputs at the output neurons of the neural network.

Thus, the method 900 operates to program resistive elements of a neural network. It should be noted that the operations shown in the method 900 are exemplary and that the operations can be changed, modified, added to, subtracted from, rearranges or otherwise modified within the scope of the invention. It should also be noted that the resistive elements may be programmed by using SET or RESET operations, or a combination of SET and RESET operations. For example, in one embodiment, all the resistive elements are initialized to high resistive state, and only SET operations are performed. In another embodiment, all the resistive elements are initialized to low resistive state, and only RESET operations are performed. In another embodiment, the resistive elements may be initialized to either high or low or a combination of high and low states, and both SET and RESET operation are performed.

While exemplary embodiments of the present invention have been shown and described, it will be obvious to those with ordinary skills in the art that based upon the teachings herein, changes and modifications may be made without departing from the exemplary embodiments and their broader aspects. Therefore, the appended claims are intended to encompass within their scope all such changes and modifications as are within the true spirit and scope of the exemplary embodiments of the present invention.

What is claimed is:

1. A method, comprising:
determining input voltages to be applied to one or more input neurons of a neural network;
determining target output voltages to be obtained at one or more output neurons of the neural network in response to the input voltages, wherein the neural network includes a plurality of hidden neurons and synapses connecting the neurons, and wherein each of a plurality of synapses includes a resistive element;
applying the input voltages to the input neurons; and
applying the target output voltages or complements of the target output voltages to the output neurons to simultaneously program the resistive elements of the plurality of synapses.

2. The method of claim 1, further comprising repeating the operations of claim 1 to simultaneously program the resistive elements of the plurality of synapses with increased accuracy.

3. The apparatus of claim 1, wherein each resistive element comprises material selected from a set of materials comprising resistive material, phase change material, ferroelectric material, and magnetic material.

4. The method of claim 1, further comprising initializing the resistive elements of the plurality of synapses to a selected resistive state prior to performing the operation of applying.

5. The method of claim 1, further comprising scaling the input voltages and the target output voltages.

6. The method of claim 1, wherein the plurality of synapses include threshold elements and the method further comprises adjusting the input voltages and the target output voltages to account for voltage threshold (Vt) drops across the threshold elements.

7. The apparatus of claim 6, wherein the threshold elements comprise threshold material selected from a set of materials comprising diode material, Schottky diode material, NbOx material, TaOx material or VCrOx material.

8. The method of claim 1, wherein each resistive element of the plurality of synapses is programmed to a respective high resistive state.

9. The method of claim 1, wherein each resistive element of the plurality of synapses is programmed to a respective low resistive state.

10. The method of claim 1, further comprising applying the input voltages to the inputs of the neural network after the resistive elements of the plurality of synapses are programmed to obtain the target outputs at the output neurons of the neural network.

11. A method for programming resistive elements of synapses of a neural network, the method comprising:
initializing the resistive elements to low resistive states;
determining input voltages to be applied to one or more input neurons of the neural network;
determining target output voltages to be obtained at one or more output neurons of the neural network in response to the input voltages;
applying the input voltages to the input neurons; and
applying the target output voltages to the output neurons to simultaneously reset each of selected resistive elements to respective high resistive states.

12. The method of claim 11, further comprising repeating the operations of claim 11 to reset each of the selected resistive elements to the respective high resistive states with increased accuracy.

13. The apparatus of claim 11, wherein the resistive elements comprise material selected from a set of materials comprising resistive material, phase change material, ferroelectric material, and magnetic material.

14. The method of claim 11, further comprising scaling the input voltages and the target output voltages.

15. The method of claim 11, wherein the synapses include threshold elements and the method further comprises adjusting the input voltages and the target output voltages to account for voltage threshold (Vt) drops across the threshold elements.

16. A method for programming resistive elements of synapses of a neural network, the method comprising:
initializing the resistive elements to high resistive states;
determining input voltages to be applied to one or more input neurons of the neural network;
determining target output voltages to be obtained at one or more output neurons of the neural network in response to the input voltages;
determining complementary target output voltages from the target output voltages;
applying the input voltages to the input neurons; and
applying the complementary target output voltages to the output neurons to simultaneously set each of selected resistive elements to respective low resistive states.

17. The method of claim 16, further comprising repeating the operations of claim 16 to set each of the selected resistive elements to the respective low resistive states with increased accuracy.

18. The apparatus of claim 16, wherein the resistive elements comprise material selected from a set of materials comprising resistive material, phase change material, ferroelectric material, and magnetic material.

19. The method of claim 16, further comprising scaling the input voltages and the complementary target output voltages.

20. The method of claim 16, wherein the synapses include threshold elements and the method further comprises adjusting the input voltages and the complementary target output voltages to account for voltage threshold (Vt) drops across the threshold elements.
